(19) United States
(12) Patent Application Publication
(10) Pub. No.: US 2017/0205348 A1
(43) Pub. Date: Jul. 20, 2017

(54) IN-LIQUID FLUORESCENCE DETECTION DEVICE AND METHOD OF DETECTING FLUORESCENCE IN LIQUID

(71) Applicant: Azbil Corporation, Tokyo (JP)

(72) Inventors: Daisuke OBARA, Tokyo (JP); Masashi FURUYA, Tokyo (JP)

(73) Assignee: Azbil Corporation, Tokyo (JP)

(21) Appl. No.: 15/479,926

(22) Filed: Apr. 5, 2017

Related U.S. Application Data
(63) Continuation of application No. PCT/JP2015/077156, filed on Sep. 25, 2015.

(30) Foreign Application Priority Data
Oct. 10, 2014 (JP) 2014-209075
Nov. 21, 2014 (JP) 2014-236527

(51) Int. Cl. G01N 21/64

(52) U.S. Cl. CPC G01N 21/6428; G01N 2021/6439

(57) ABSTRACT

To provide an in-liquid fluorescence detection device capable of accurately detecting fluorescence in a liquid.

An in-liquid fluorescence detection device includes a light source emitting an excitation light having a wavelength in which Raman scattered light is generated in a liquid in a wavelength band between first and second fluorescence wavelength bands toward the liquid, which can contain a first substance that emits light having higher intensities in the first fluorescence wavelength band as compared with in the second fluorescence wavelength band and a second substance that emits light having higher intensities in the second fluorescence wavelength band as compared with in the first fluorescence wavelength band; and a fluorescence detection unit detecting light in the first and second fluorescence wavelength bands.

### CROSS-REFERENCE TO RELATED APPLICATIONS

The present application claims the benefit of and priority to Japanese Patent Application No. 2014-209075, filed on Oct. 10, 2014; Japanese Patent Application No. 2014-236527, filed on Nov. 21, 2014; and International patent application Ser. No. PCT/JP2015/077156, filed on Sep. 25, 2015, the entire contents of which are incorporated by reference herein.

### TECHNICAL FIELD

The present invention relates to a detection technique, and relates to an in-liquid fluorescence detection device and a method of detecting fluorescence in a liquid.

### BACKGROUND

A method of detecting fluorescent particles included in a gas as an inspection object (for example, refer to Patent Literatures 1 and 2) and a method of detecting fluorescent particles included in a liquid as an inspection object (for example, refer to Patent Literature 3) are proposed. In every method, it is determined that particles exist when an inspection object is irradiated with an excitation light and fluorescence is detected.

### CITATION LIST

### Patent Literature

[Patent Literature 1] Japanese Patent No. 4377064

[Patent Literature 2] JP-A-2012-88304

[Patent Literature 3] JP-A-2013-117466

### SUMMARY

In general, Raman scattering with light intensity that interferes with detection of fluorescent particles emitting autofluorescence is not generated when a gas is irradiated with an excitation light. However, when a liquid is irradiated with an excitation light, Raman scattering with a level of light intensity that interferes with detection of fluorescent particles emitting autofluorescence may be generated due to molecules forming a liquid, such as water, or molecules contained in the liquid. As a wavelength of Raman scattered light is longer than a wavelength of the excitation light, the wavelength of the Raman scattered light may overlap with a wavelength of fluorescence emitted by fluorescent particles contained in the inspection object. The inspection object may also contain plural kinds of fluorescent particles.

In view of the above, an object of the present invention is to provide an in-liquid fluorescence detection device and a method of detecting fluorescence in a liquid capable of accurately detecting fluorescence in the liquid.

An in-liquid fluorescence detection device according to an embodiment of the present invention includes (a) a light source emitting an excitation light having a wavelength in which Raman scattered light is generated in a liquid in a wavelength band between first and second fluorescence wavelength bands toward the liquid, which can contain a first substance that emits light having higher intensities in the first fluorescence wavelength band as compared with light emitted in the second fluorescence wavelength band and a second substance that emits light having higher intensities in the second fluorescence wavelength band as compared with light emitted in the first fluorescence wavelength band and (b) a fluorescence detection unit detecting light in the first and second fluorescence wavelength bands.

The device may further include a comparison unit comparing an intensity of detected light in the first fluorescence wavelength band with an intensity of light in the second fluorescence wavelength band. The device may further include a determination unit determining that the liquid contains the first substance when the intensity of light in the first fluorescence wavelength band is higher than the intensity of light in the second fluorescence wavelength band, and determining that the liquid contains the second substance when the intensity of light in the second fluorescence wavelength band is higher than the intensity of light in the first fluorescence wavelength band.

In the device, the first substance may be a biotic particle and the second substance may be an abiotic particle. Moreover, the first fluorescence wavelength band may be positioned on a longer wavelength side than the second fluorescence wavelength band. Furthermore, light in the first fluorescence wavelength band may be autofluorescence emitted by the biotic particle and light in the second fluorescence wavelength band may be autofluorescence emitted by the abiotic particle.

Also in the device, the first and second substances may be abiotic particles, and at least one of the first and second substances may be a fluorescent substance dissolved in the liquid.

The device may further include a scattering light detection unit detecting scattering light having the same wavelength as the excitation light, which is generated in the liquid irradiated with the excitation light.

A method of detecting fluorescence in a liquid according to an embodiment of the present invention includes the steps of (a) emitting an excitation light having a wavelength in which Raman scattered light is generated in a liquid in a wavelength band between first and second fluorescence wavelength bands toward the liquid which can contain a first substance that emits light having higher intensities in the first fluorescence wavelength band as compared with light emitted in the second fluorescence wavelength band and a second substance that emits light having higher intensities in the second fluorescence wavelength band as compared with light emitted in the first fluorescence wavelength band and (b) detecting light in the first and second fluorescence wavelength bands.

The method may further include the step of comparing an intensity of detected light in the first fluorescence wavelength band with an intensity of light in the second fluorescence wavelength band. The method may further include the steps of determining that the liquid contains the first substance when the intensity of light in the first fluorescence wavelength band is higher than the intensity of light in the second fluorescence wavelength band and determining that the liquid contains the second substance when the intensity of light in the second fluorescence wavelength band is higher than the intensity of light in the first fluorescence wavelength band.

In the method, the first substance may be a biotic particle and the second substance may be an abiotic particle. Also in the method, the first fluorescence wavelength band may be positioned on a longer wavelength side than the second fluorescence wavelength band. Furthermore, in the method, light in the first fluorescence wavelength band may be autofluorescence emitted by the biotic particle and light in the second fluorescence wavelength band may be autofluorescence emitted by the abiotic particle.

Also in the method, the first and second substances may be abiotic particles, and at least one of the first and second substances may be a fluorescent substance dissolved in the liquid.

The method may further include the step of detecting scattering light having the same wavelength as the excitation light, which is generated in the liquid irradiated with the excitation light.

According to the present invention, an in-liquid fluorescence detection device and a method of detecting fluorescence in a liquid capable of accurately detecting fluorescence in the liquid can be provided.

### BRIEF DESCRIPTION OF THE DRAWINGS

FIG. 1 is a schematic view of an in-liquid fluorescence detection device according to a first embodiment of the present invention.

FIG. 2 shows examples of fluorescence spectra of autofluorescence emitted by microorganisms according to the first embodiment of the present invention.

FIG. 3 shows examples of fluorescence spectra of autofluorescence emitted by abiotic particles according to the first embodiment of the present invention.

FIG. 4 is a graph obtained by overlapping the spectra shown in FIG. 2 and FIG. 3 with each other.

FIG. 5 shows an example of a fluorescence spectrum of autofluorescence emitted by a microorganism according to the first embodiment of the present invention.

FIG. 6 shows examples of fluorescence spectra of autofluorescence emitted by abiotic particles according to the first embodiment of the present invention.

FIG. 7 is a graph obtained by overlapping the spectra shown in FIG. 5 and FIG. 6 with each other.

FIG. 8 shows an example of a fluorescence spectrum of autofluorescence emitted by a microorganism according to the first embodiment of the present invention.

FIG. 9 shows an example of a fluorescence spectrum of autofluorescence emitted by abiotic particles according to the first embodiment of the present invention.

FIG. 10 is a graph obtained by overlapping the spectra shown in FIG. 9 and FIG. 10 with each other.

FIG. 11 shows an example of a fluorescence spectrum of autofluorescence emitted by abiotic particles formed of glass according to a second embodiment of the present invention.

FIG. 12 shows an example of a fluorescence spectrum of autofluorescence emitted by abiotic particles formed of PET according to the second embodiment of the present invention.

FIG. 13 is a graph obtained by overlapping the spectra shown in FIG. 11 and FIG. 12 with each other.

FIG. 14 shows an example of a fluorescence spectrum of fluorescence emitted by alcohol for disinfection according to a third embodiment of the present invention.

FIG. 15 shows an example of a fluorescence spectrum of fluorescence emitted by green tea according to the third embodiment of the present invention.

FIG. 16 is a graph obtained by overlapping the spectra shown in FIG. 14 and FIG. 15 with each other.

### DETAILED DESCRIPTION

Hereinafter, embodiments of the present invention will be explained. In the description of the drawings, the same or similar numerals and signs are given to the same or similar portions. However, the drawings are schematic. Accordingly, specific sizes and so on should be determined by referring to the following explanation.

### First Embodiment

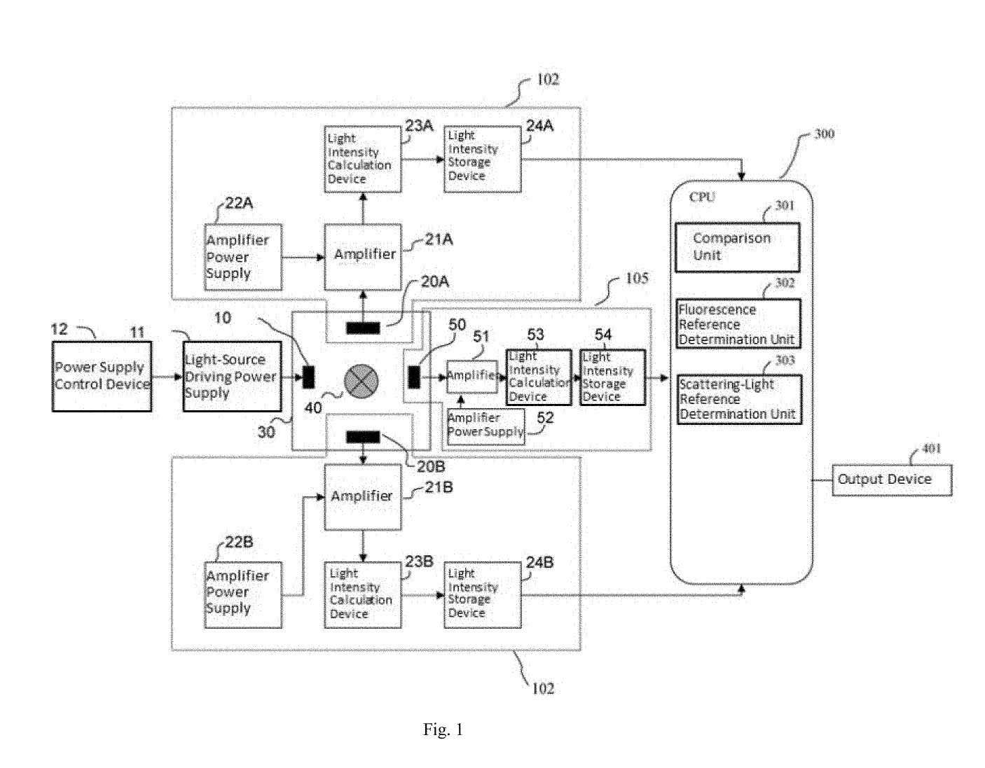

An in-liquid fluorescence detection device according to a first embodiment of the present invention includes a light source 10 emitting an excitation light having a wavelength in which Raman scattered light is generated in a liquid in a wavelength band between first and second fluorescence wavelength bands toward the liquid in a cell 40, which may contain a first substance that emits light having higher intensities in the first fluorescence wavelength band as compared with light emitted in the second fluorescence wavelength band and a second substance that emits light having higher intensities in the second fluorescence wavelength band as compared with light emitted in the first fluorescence wavelength band, and a fluorescence detection unit 102 detecting light in the first and second fluorescence wavelength bands, as shown in FIG. 1.

For example, the first substance that may be contained in the liquid in cell 40 is formed of a biotic particle, such as microorganisms, and the second substance may be formed of an abiotic particle. The description that the liquid may contain the first substance and the second substance means that there is a possibility that the liquid contains the first substance and the second substance, and that there may be a case where it is determined that the liquid does not contain the first substance and the second substance as a result of the inspection.

The in-liquid fluorescence detection device may further include a scattering light detection unit 105 detecting scattering light having the same wavelength as the excitation light, which is generated in the liquid irradiated with the excitation light. The light source 10, the fluorescence detection unit 102, and the scattering light detection unit 105 are provided in a casing 30. A light source driving power supply 11 supplying power to the light source 10 is connected to the light source 10. A power supply control device 12 controlling the power to be supplied to the light source 10 is connected to the light source driving power supply 11. The liquid irradiated with the excitation light flows inside the transparent cell 40. The liquid irradiated with the excitation light is, for example, pure water, pharmaceutical water, injection solvent and culture solution, however, the liquid is not limited to the above. The cell 40 may be connected to, for example, piping of a plant, however, the present invention is not limited to the above.

The light source 10 emits an excitation light of a broadband wavelength toward the liquid flowing inside the cell 40. As the light source 10, for example, a light emitting diode (LED) and laser can be used. A wavelength of the excitation light is, for example, 250 to 550 nm. The excitation light may be visible light as well as ultraviolet light. In the case where the excitation light is visible light, a wavelength of the excitation light is, for example, in a range of 400 to 550 nm, and, for example, at about 405 nm. In the case where the excitation light is ultraviolet light, a wavelength of the excitation light is, for example, in a range of 300 to 380 nm, and, for example, at about 340 nm. However, the wavelengths of the excitation light are not limited to the above.

In the case where microorganisms, such as bacteria, are contained in the liquid inside the cell 40, nicotinamide adenine dinucleotide, riboflavin, and the like, contained in the microorganisms irradiated with the excitation light emit fluorescence. Also in the case where non-microorganism particles formed of, for example, metal or resin are contained in the liquid inside the cell 40, non-microorganism particles irradiated with the excitation light may emit fluorescence or light, the wavelength band of which overlaps with that of fluorescence. The fluorescence includes autofluorescence.

For example, when the liquid is water manufactured by a purified water producing device, water may contain non-microorganism particles formed of materials for the purified water producing device. For example, particles containing at least one material selected from polypropylene, polyethylene, polytetrafluoroethylene (PTFE), olefin, polycarbonate, polyurethane, and the like, may be generated from a filter or a housing, which may be provided in the purified water producing device. For example, particles containing at least one material selected from silicone rubber, nitrile rubber (NBR), ethylene-propylene rubber (EPDM), fluororubber, kalrez, PTFE, and the like, may be generated from a gasket, which may be provided in the purified water producing device. Moreover, particles containing at least one material selected from viton, fluororesin, silicone resin, polyamide, polyphenylene sulfide (PPS), perfluoroelastomer, and the like, may be generated from a pump, which may be provided in the purified water producing device. Furthermore, particles containing, for example, PTFE, and the like, may be generated from a sealing, which may be provided in the purified water producing device. Additionally, particles containing a metal material, such as oxidation stainless steel, may be generated from piping, which may be provided in the purified water producing device. The above-described materials of particles to be generated from the purified water producing device may emit fluorescence or light, the wavelength band of which overlaps with that of fluorescence when irradiated with the excitation light.

Spectrums of light in the fluorescence band emitted by microorganisms and non-microorganism particles differ according to types of microorganisms and non-microorganism particles. An intensity of light in the fluorescence wavelength band emitted by microorganisms generally tends to be higher on the long wavelength side than an intensity of light in the fluorescence wavelength band emitted by non-microorganism particles. Accordingly, it is possible to determine whether substances, such as particles, contained in the liquid are microorganisms or non-microorganism particles based on intensities of light in the fluorescence band detected in plural wavelengths.

When the liquid is irradiated with the excitation light, the excitation light is scattered by molecules contained in the liquid, and Raman scattered light having a longer wavelength than that of the excitation light is generated. For example, Raman scattered light having wavelengths 50 to 100 nm or 60 to 70 nm longer than the wavelength of the excitation light is generated in water. The wavelength band of Raman scattered light varies chiefly according to the type of molecules and the wavelength of the excitation light. Specifically, when the wavelength of the excitation light is 380 nm, a peak of Raman scattered light is generated in the vicinity of 436 nm in wavelength in water. When the wavelength of the excitation light is 405 nm, a peak of Raman scattered light is generated in the vicinity of 469 nm in wavelength in water. When the wavelength of the excitation light is 490 nm, a peak of Raman scattered light is generated in the vicinity of 535 nm and in the vicinity of 585 nm in wavelength in water.

Accordingly, when the peak wavelength of Raman scattered light overlaps with the wavelength of light in the fluorescence band, such as autofluorescence with a low intensity generated by microorganisms or non-microorganism particles, Raman scattered light acts as stray light. Therefore, it may be difficult to detect autofluorescence with a low intensity, which is an original detection object. Moreover, it may be wrongly determined that microorganisms or non-microorganism particles are contained in the liquid.

In response to the above, the in-liquid fluorescence detection device according to the first embodiment emits the excitation light having a wavelength in which Raman scattered light is generated in a wavelength band between a first fluorescence wavelength band, in which the intensity of fluorescence emitted by microorganisms is higher, and a second fluorescence wavelength band, in which the intensity of fluorescence emitted by non-microorganism particles is higher.

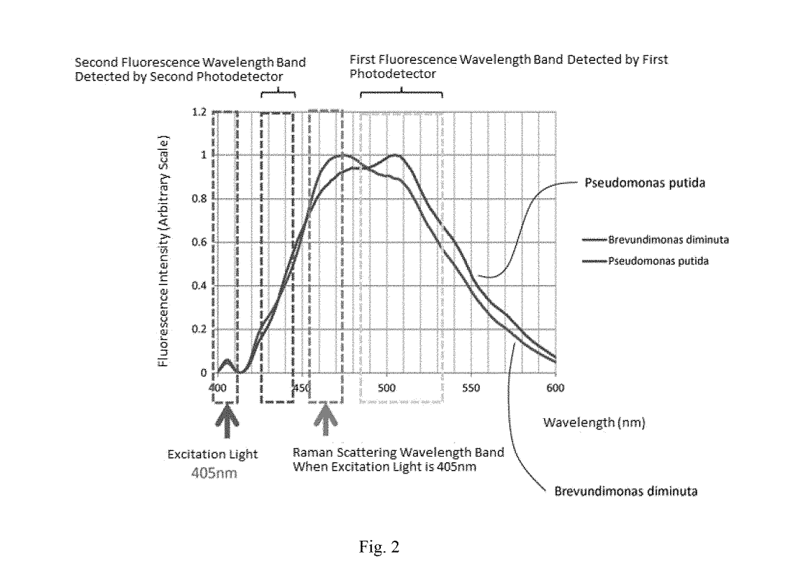

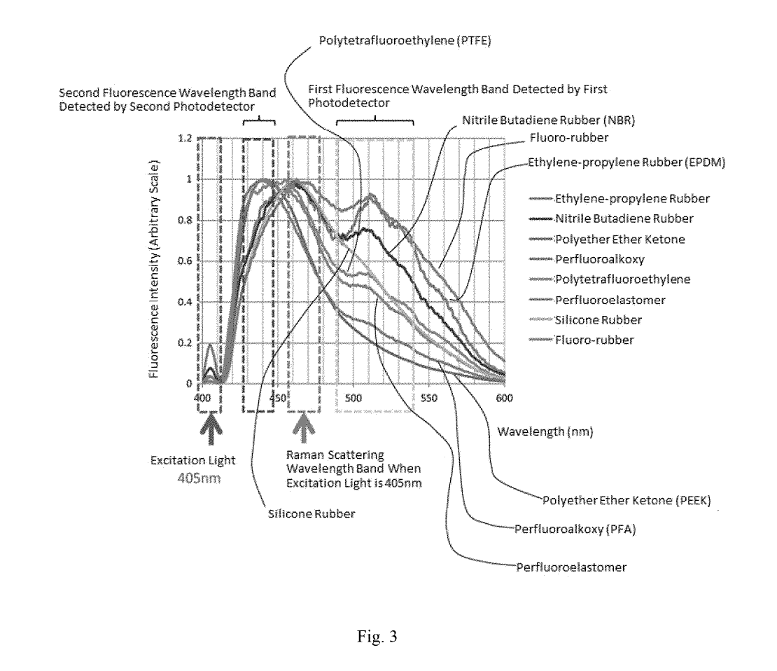

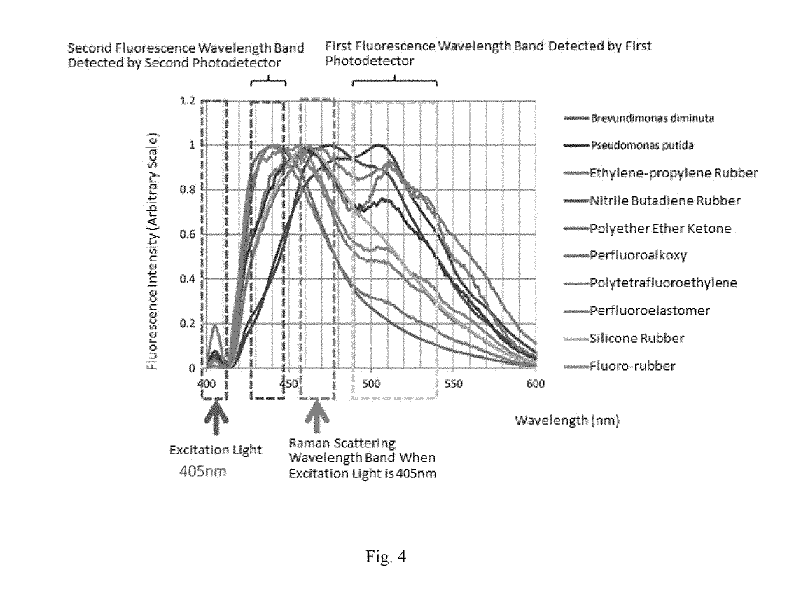

FIG. 2 shows examples of spectra of autofluorescence emitted by Brevundimonas diminuta (ATCC 19146) and Pseudomonas putida (ATCC 12633) as aquatic bacteria obtained when irradiated with an excitation light having a wavelength of 405 nm. FIG. 3 shows examples of spectra of autofluorescence emitted by abiotic particles generated from various resin gasket materials when irradiated with the excitation light having the wavelength of 405 nm. FIG. 4 is a graph obtained by overlapping the spectra shown in FIG. 2 with the spectra shown in FIG. 3. As shown in FIG. 2 to FIG. 4, the spectra of autofluorescence emitted by microorganisms have higher intensities on the long wavelength side as compared with the spectra of autofluorescence emitted by abiotic particles. In contrast, the spectra of autofluorescence emitted by abiotic particles have higher intensities on the short wavelength side as compared with the spectra of autofluorescence emitted by microorganisms. In this case, the peak of Raman scattered light is generated in the vicinity of 469 nm in wavelength in water. The spectra of autofluorescence emitted by microorganisms have higher intensities on the longer wavelength side of the peak of Raman scattered light. In contrast, the spectra of autofluorescence emitted by abiotic particles have higher intensities on the shorter wavelength side of the peak of Raman scattered light.

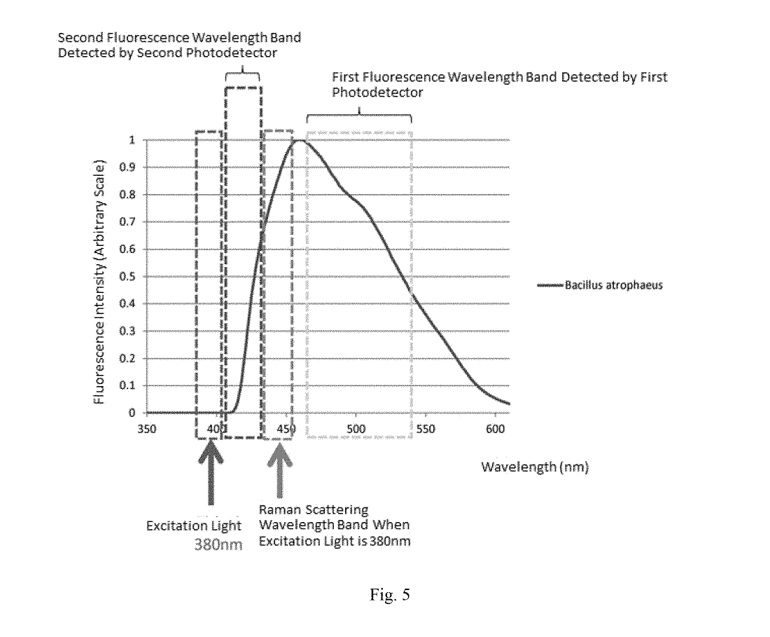

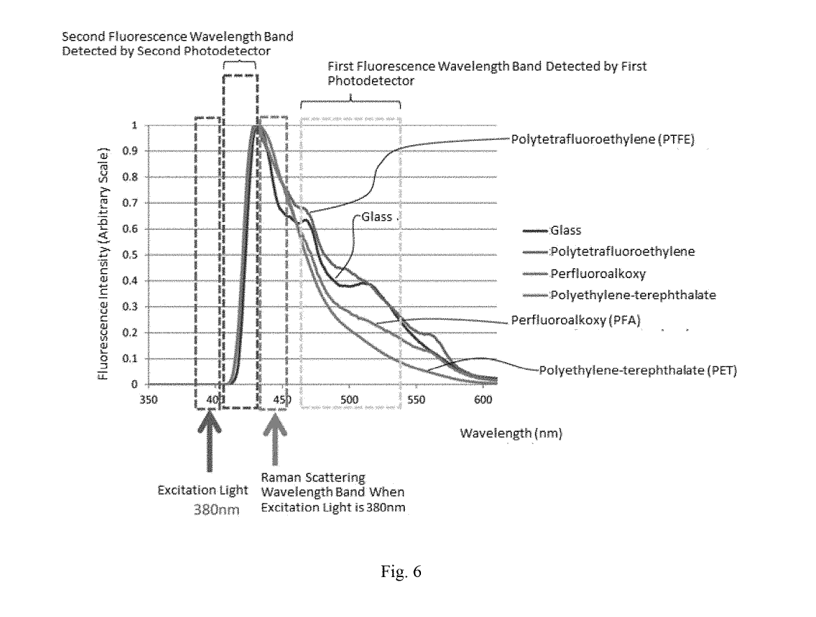

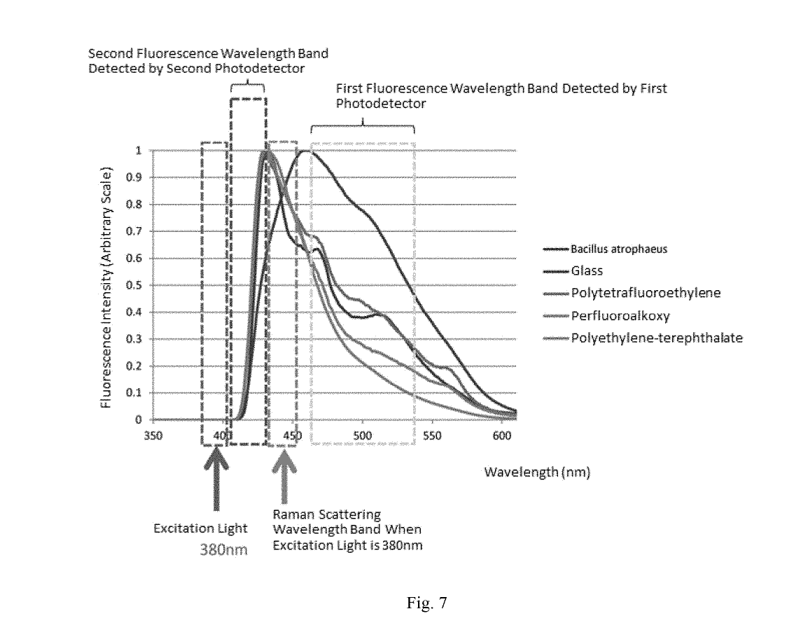

FIG. 5 shows an example of a spectrum of autofluorescence emitted by Bacillus atrophaeus as Bacillus subtilis obtained when irradiated with an excitation light having a wavelength of 380 nm. FIG. 6 shows examples of spectra of autofluorescence emitted by abiotic particles containing glass and various resin materials when irradiated with the excitation light having the wavelength of 380 nm. FIG. 7 is a graph obtained by overlapping the spectrum shown in FIG. 5 and the spectra shown in FIG. 6 with each other. As shown in FIG. 5 to FIG. 7, the spectrum of autofluorescence emitted by the microorganism has higher intensities on the long wavelength side as compared with the spectra of autofluorescence emitted by abiotic particles. In contrast, the spectra of autofluorescence emitted by abiotic particles have higher intensities on the short wavelength side as compared with the spectrum of autofluorescence emitted by the microorganism. In this case, the peak of Raman scattered light is generated in the vicinity of 436 nm in wavelength in water. The spectrum of autofluorescence emitted by microorganism has higher intensities on the longer wavelength side of the peak of Raman scattered light. In contrast, the spectra of autofluorescence emitted by abiotic particles have higher intensities on the shorter wavelength side of the peak of Raman scattered light.

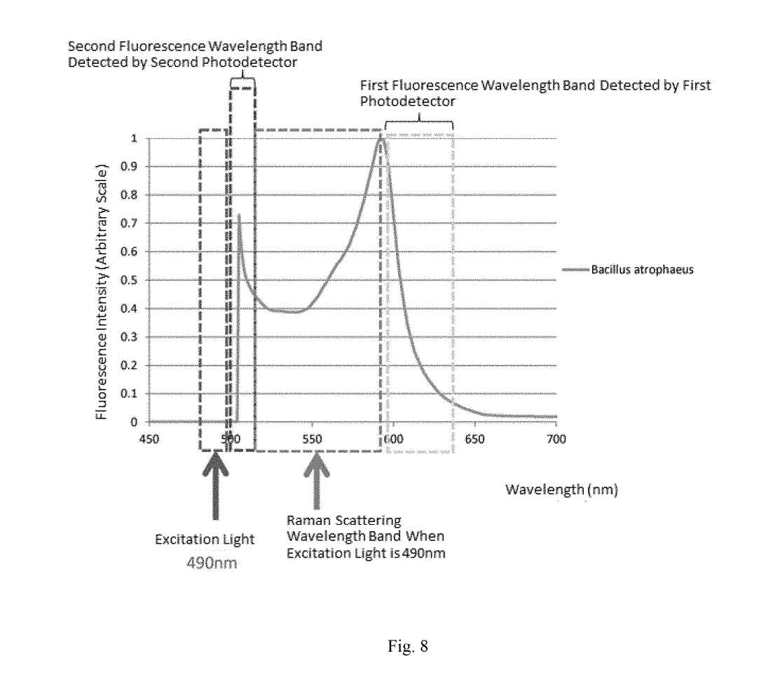

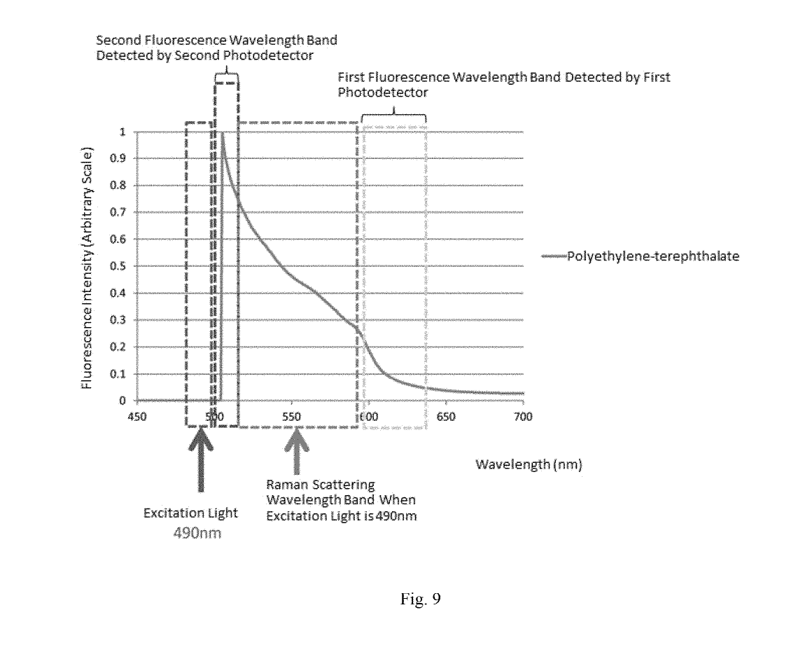

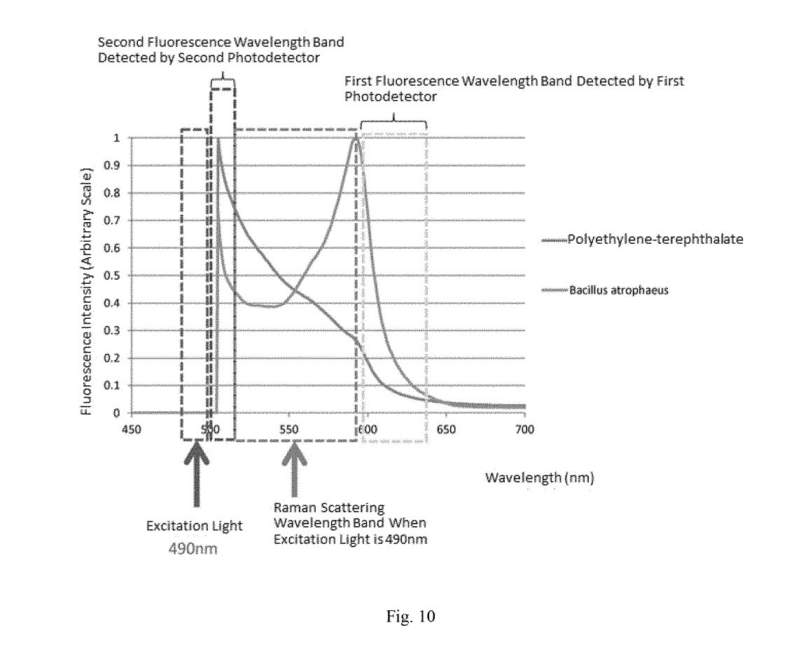

FIG. 8 shows an example of a spectrum of autofluorescence emitted by Bacillus atrophaeus as Bacillus subtilis obtained when irradiated with an excitation light having a wavelength of 490 nm. FIG. 9 shows an example of a spectrum of autofluorescence emitted by abiotic particles containing polyethylene-terephthalate (PET) when irradiated with the excitation light having the wavelength of 490 nm. FIG. 10 is a graph obtained by overlapping the spectrum shown in FIG. 8 with the spectrum shown in FIG. 9. As shown in FIG. 8 to FIG. 10, the spectrum of autofluorescence emitted by the microorganism has higher intensities on the long wavelength side as compared with the spectrum of autofluorescence emitted by abiotic particles. In contrast, the spectrum of autofluorescence emitted by abiotic particles has higher intensities on the short wavelength side as compared with the spectrum of autofluorescence emitted by the microorganism. In this case, the peaks of Raman scattered light are generated in the vicinity of 535 nm and in the vicinity of 585 nm in wavelength in water. The spectrum of autofluorescence emitted by microorganism has higher intensities on the longer wavelength side of the peaks of Raman scattered light. In contrast, the spectrum of autofluorescence emitted by abiotic particles has higher intensities on the shorter wavelength side of the peaks of Raman scattered light.

The light source 10 shown in FIG. 1 emits an excitation light having a wavelength in which the wavelength band of Raman scattered light is positioned between the spectrum of autofluorescence emitted by microorganisms and the spectrum of autofluorescence emitted by abiotic particles. Alternatively, the light source 10 emits an excitation light having a wavelength in which the wavelength band of Raman scattered light is positioned in a portion where a lower intensity portion (on a short wavelength side of an intensity peak; e.g., comprising an intensity bottom) on the spectrum of autofluorescence emitted by microorganisms overlaps with a lower intensity portion (on a long wavelength side of an intensity peak; e.g., comprising an intensity bottom) on the spectrum of autofluorescence emitted by abiotic particles. (It is noted that the wavelength band of Raman scattered light may encompass one or more of the intensity peaks).

The fluorescence detection unit 102 detects light in fluorescence bands emitted by microorganisms or non-microorganism particles. The fluorescence detection unit 102 includes a first photodetector 20A receiving light in the first fluorescence wavelength band and a second photodetector 20B receiving light in the second fluorescence wavelength band which is different from the first fluorescence wavelength band. The first and second photodetectors 20A and 20B may be configured so as not to detect light in wavelength bands of Raman scattered light. For example, the wavelength band of Raman scattered light may be excluded from wavelength bands that can be detected by the first and second photodetectors 20A and 20B. It is also possible to arrange a filter, a bandpass filter, a long-pass filter, a short-pass filter, and a dichroic mirror, as well as wavelength selection means formed by combining the above. and so on, for blocking light in the wavelength band of Raman scattered light in a front stage of the first and second photodetectors 20A and 20B. As the first and second photodetectors 20A and 20B, photodiodes, photomultiplier tubes, and so on may be used, which convert light energy into electric energy when receiving light.

An amplifier 21A amplifying an electric current generated in the first photodetector 20A is connected to the first photodetector 20A. An amplifier power supply 22A supplying power to the amplifier 21A is connected to the amplifier 21A. A light intensity calculation device 23A receiving the electric current amplified in the amplifier 21A and calculating a light intensity received by the first photodetector 20A is also connected to the amplifier 21A. The light intensity calculation device 23A calculates the light intensity, for example, based on an area of a spectrum of detected light. A light intensity storage device 24A storing the light intensity calculated by the light intensity calculation device 23A is connected to the light intensity calculation device 23A.

An amplifier 21B amplifying an electric current generated in the second photodetector 20B is connected to the second photodetector 20B. An amplifier power supply 22B supplying power to the amplifier 21B is connected to the amplifier 21B. A light intensity calculation device 23B receiving the electric current amplified in the amplifier 21B and calculating a light intensity received by the second photodetector 20B is also connected to the amplifier 21B. The light intensity calculation device 23B calculates the light intensity, for example, based on an area of a spectrum of detected light. A light intensity storage device 24B storing the light intensity calculated by the light intensity calculation device 23B is connected to the light intensity calculation device 23B.

The scattering light detection unit 105 detects scattering light generated by microorganisms, non-microorganism particles, and air bubbles irradiated with an inspection light. The scattering light detection unit 105 includes a scattering light photodetector 50 receiving scattering light. As the scattering light photodetector 50, a photodiode, or the like, can be used, which converts light energy into electric energy when receiving light.

An amplifier 51 amplifying an electric current generated in the scattering light photodetector 50 is connected to the scattering light photodetector 50. An amplifier power supply 52 supplying power to the amplifier 51 is connected to the amplifier 51. A light intensity calculation device 53 receiving the electric current amplified in the amplifier 51 and calculating an intensity of scattering light received by the scattering light photodetector 50 is also connected to the amplifier 51. A light intensity storage device 54 storing the intensity of scattering light calculated by the light intensity calculation device 53 is connected to the light intensity calculation device 53.

When a liquid flows inside the cell 40, the light source 10 emits the excitation light and the fluorescence detection unit 102 measures an intensity of light in the first fluorescence wavelength band on the longer wavelength side of the wavelength band of Raman scattered light and an intensity of light in the second fluorescence wavelength band on the shorter wavelength side of the wavelength band of Raman scattered light, storing the intensities in time series in the light intensity storage devices 24A and 24B. The scattering light detection unit 105 detects scatting light and stores light intensities of scattering light in time series in the light intensity storage device 54.

The in-liquid fluorescence detection device according to the first embodiment further includes a central processing unit (CPU) 300. The CPU 300 includes a scattering-light reference determination unit 303. The scattering-light reference determination unit 303 reads a value of the intensity of light in the first fluorescence wavelength band and a value of the intensity of light in the second fluorescence wavelength band from the light intensity storage devices 24A and 24B. The scattering-light reference determination unit 303 reads an intensity of scattering light from the light intensity storage unit 54.

The scattering-light reference determination unit 303 determines that water as an inspection object contains air bubbles when the fluorescence detection unit 102 does not detect light in the fluorescence band and the scattering light detection unit 105 detects scattering light. Moreover, the scattering-light reference determination unit 303 may determine that water as the inspection object does not contain microorganisms and non-microorganism particles when the fluorescence detection unit 102 does not detect light in the fluorescence band and the scattering light detection unit 105 detects scattering light. Furthermore, scattering-light reference determination unit 303 may determine that water as the inspection object contains microorganisms or non-microorganism particles when the fluorescence detection unit 102 detects light in the fluorescence band and the scattering light detection unit 105 detects scattering light.

The CPU 300 may further include a comparison unit 301 and a fluorescence reference determination unit 302. The comparison unit 301 reads a value of the intensity of the detected light in the first fluorescence wavelength band and a value of the intensity of light in the second fluorescence wavelength band from the light intensity storage units 24A and 24B. The comparison unit 301 also compares the intensity of light in the first fluorescence wavelength band with the intensity of light in the second fluorescence wavelength band. The fluorescence reference determination unit 302 determines that the liquid contains microorganisms when the intensity of light in the first fluorescence wavelength band on the longer wavelength side of the wavelength band of Raman scattered light is higher than the intensity of light in the second fluorescence wavelength band on the shorter wavelength side of the wavelength band of Raman scattered light. The fluorescence reference determination unit 302 also determines that the liquid contains abiotic particles when the intensity of light in the second fluorescence wavelength band on the shorter wavelength side of the wavelength band of Raman scattered light is higher than the intensity of light in the first fluorescence wavelength band on the longer wavelength side of the wavelength band of Raman scattered light.

The fluorescence reference determination unit 302 outputs, for example, a determination result from an output device 401. As the output device 401, a display, a speaker, a printer, and the like can be used.

In the above explained in-liquid fluorescence detection device according to the first embodiment, it is possible to suppress a case where Raman scattered light is wrongly determined as autofluorescence emitted by microorganisms or non-microorganism particles contained in the liquid even when Raman scattered light is generated.

### Second Embodiment

In a second embodiment, a method of discriminating between a first abiotic particle and a second abiotic particle different from the first abiotic particle will be explained.

In the second embodiment, the light source 10 shown in FIG. 1 emits an excitation light having a wavelength in which the wavelength band of Raman scattered light is positioned between a spectrum of autofluorescence emitted by the first abiotic particle and a spectrum of autofluorescence emitted by the second abiotic particle. Alternatively, the light source 10 emits an excitation light having a wavelength in which the wavelength band of Raman scattered light is positioned in a portion where a lower intensity portion (on a short wavelength side of an intensity peak; e.g., comprising an intensity bottom) on the spectrum of autofluorescence emitted by the first abiotic particle overlaps with a lower intensity portion (on a long wavelength side of an intensity peak; e.g., comprising an intensity bottom) on the spectrum of autofluorescence emitted by the second abiotic particle. (It is noted that the wavelength band of Raman scattered light may encompass one or more of the intensity peaks).

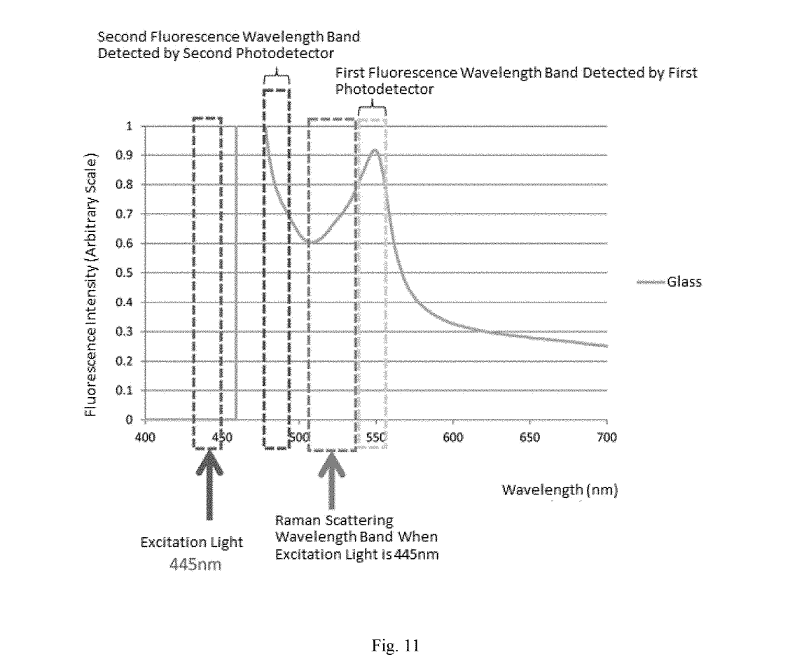

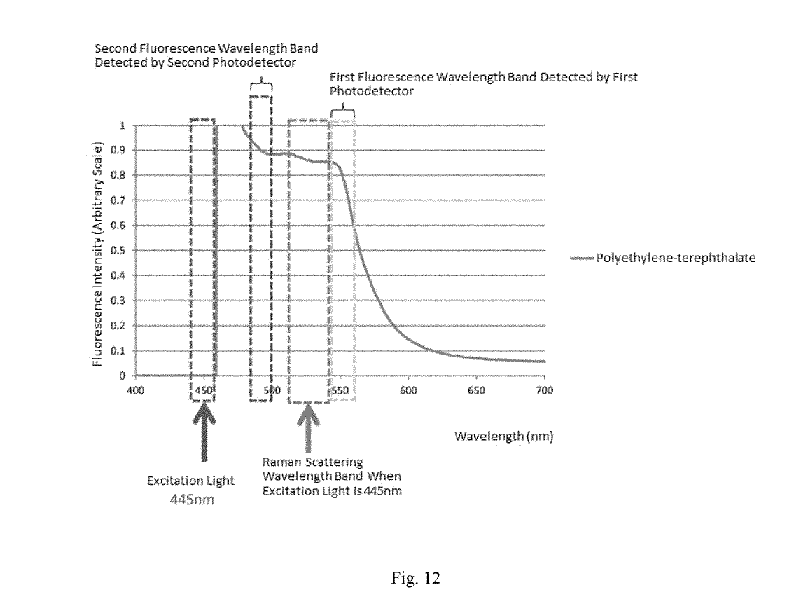

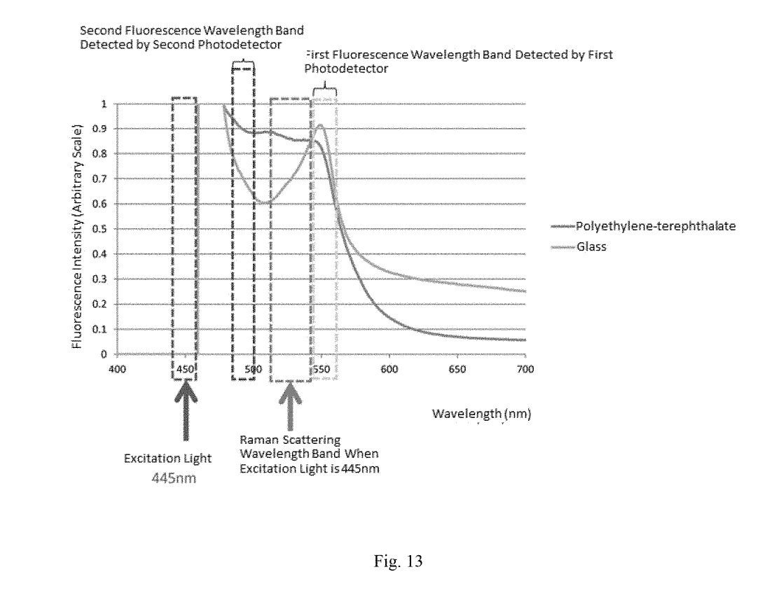

FIG. 11 shows an example of a spectrum of autofluorescence emitted by abiotic particles formed of glass when irradiated with an excitation light having a wavelength of 445 nm. FIG. 12 shows an example of a spectrum of autofluorescence emitted by abiotic particles formed of polyethylene-terephthalate (PET) when irradiated with the excitation light having the wavelength of 445 nm. FIG. 13 is a graph obtained by overlapping the spectrum shown in FIG. 11 with the spectrum shown in FIG. 12. As shown in FIG. 11 to FIG. 13, the spectrum of autofluorescence emitted by abiotic particles formed of glass has higher intensities on the long wavelength side as compared with the spectrum of autofluorescence emitted by abiotic particles formed of PET. In contrast, the spectrum of autofluorescence emitted by abiotic particles formed of PET has higher intensities on the short wavelength side as compared with the spectrum of autofluorescence emitted by abiotic particles formed of glass. In this case, a peak of Raman scattered light is generated in the vicinity of 524 nm in wavelength in water. The spectrum of autofluorescence emitted by abiotic particles formed of glass has higher intensities on the longer wavelength side of the peak of Raman scattered light. In contrast, the spectrum of autofluorescence emitted by abiotic particles formed of PET has higher intensities on the shorter wavelength side of the peak of Raman scattered light.

In the second embodiment, the comparison unit 301 in the CPU 300 shown in FIG. 1 compares an intensity of light in the first fluorescence wavelength band with an intensity of light in the second fluorescence wavelength band. The fluorescence reference determination unit 302 determines that the liquid contains the first abiotic particle when the intensity of light in the first fluorescence wavelength band on the long wavelength side of the wavelength band of Raman scattered light is higher than the intensity of light in the second fluorescence wavelength band on the short wavelength side of the wavelength band of Raman scattered light. The fluorescence reference determination unit 302 also determines that the liquid contains the second abiotic particle when the intensity of light in the second fluorescence wavelength band on the short wavelength side of the wavelength band of Raman scattered light is higher than the intensity of light in the first fluorescence wavelength band on the long wavelength side of the wavelength band of Raman scattered light.

### Third Embodiment

In a third embodiment, a method of discriminating between a first fluorescence substance dissolved in a liquid and a second fluorescence substance dissolved in the liquid different from the first fluorescence substance will be explained.

In the third embodiment, the light source 10 shown in FIG. 1 emits an excitation light having a wavelength in which the wavelength band of Raman scattered light is positioned between a spectrum of fluorescence emitted by the first fluorescence substance dissolved in the liquid and a spectrum of fluorescence emitted by the second fluorescence substance dissolved in the liquid. Alternatively, the light source 10 emits an excitation light having a wavelength in which the wavelength band of Raman scattering light is positioned in a portion where a lower intensity portion (on a short wavelength side of an intensity peak; e.g., comprising an intensity bottom) on the spectrum of fluorescence emitted by the first fluorescence substance dissolved in the liquid overlaps with a lower intensity portion (on a long wavelength side of an intensity peak; e.g., comprising an intensity bottom) on the spectrum of fluorescence emitted by the second fluorescence substance dissolved in the liquid. (It is noted that the wavelength band of Raman scattered light may encompass one or more of the intensity peaks).

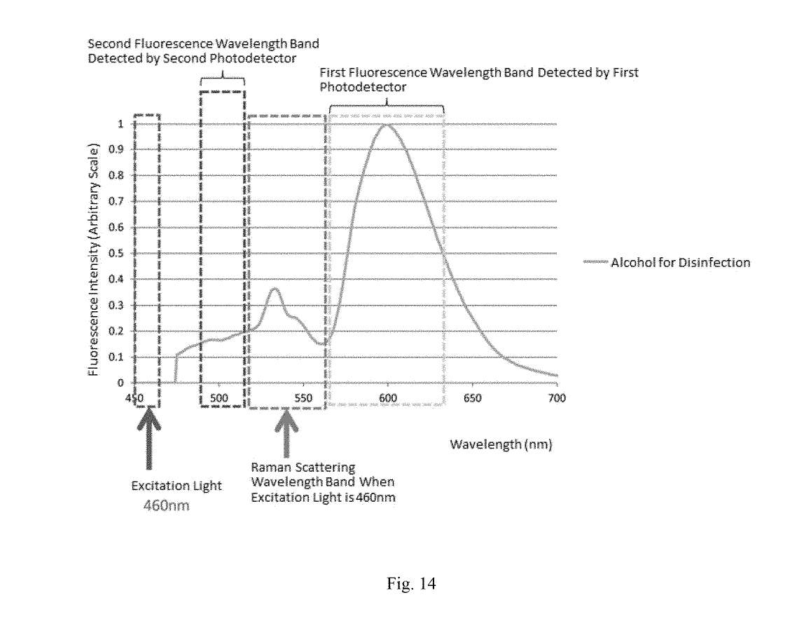

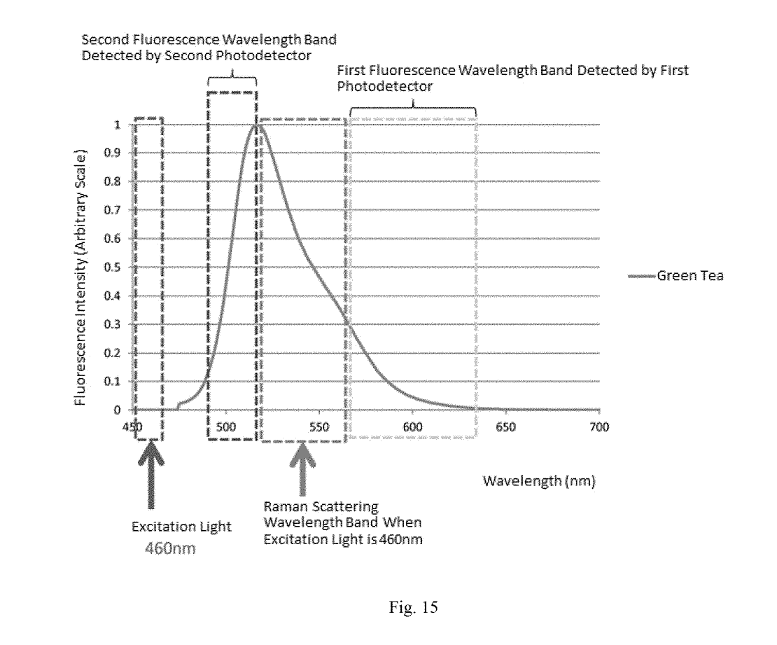

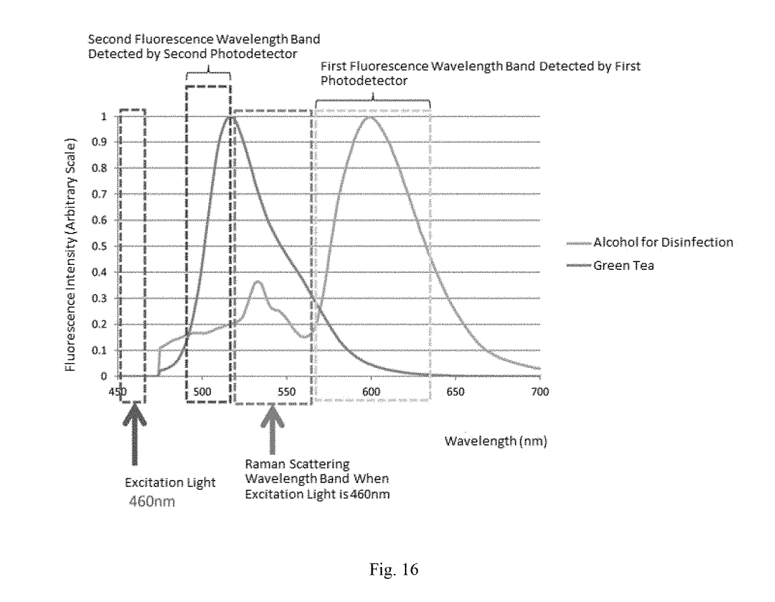

FIG. 14 shows an example of a spectrum of fluorescence emitted by additives, such as perfume and pigment, contained in alcohol for disinfection when irradiated with an excitation light having a wavelength of 460 nm. FIG. 15 shows an example of a spectrum of fluorescence emitted by chlorophyll contained in green tea when irradiated with the excitation light having the wavelength of 460 nm. FIG. 16 is a graph obtained by overlapping the spectrum shown in FIG. 14 with the spectrum shown in FIG. 15. As shown in FIG. 14 to FIG. 16, the spectrum of fluorescence emitted by the additives, such as perfume and pigment, contained in alcohol for disinfection has higher intensities on the long wavelength side as compared with the spectrum of fluorescence emitted by chlorophyll contained in green tea. In contrast, the spectrum of fluorescence emitted by chlorophyll contained in green tea has higher intensities on the short wavelength side as compared with the spectrum of fluorescence emitted by the additives, such as perfume and pigment, contained in alcohol for disinfection. In this case, a peak of Raman scattered light is generated in the vicinity of 545 nm in wavelength in water. The spectrum of fluorescence emitted by the additives, such as perfume and pigment, contained in alcohol for disinfection has higher intensities on the longer wavelength side of the peak of Raman scattered light. In contrast, the spectrum of fluorescence emitted by chlorophyll contained in green tea has higher intensities on the shorter wavelength side of the peak of Raman scattered light.

In the third embodiment, the comparison unit 301 in the CPU 300 shown in FIG. 1 compares an intensity of light in the first fluorescence wavelength band with an intensity of light in the second fluorescence wavelength band. The fluorescence reference determination unit 302 determines that the liquid contains the additives, such as perfume and pigment, contained in alcohol for disinfection when the intensity of light in the first fluorescence wavelength band on the long wavelength side of the wavelength band of Raman scattered light is higher than the intensity of light in the second fluorescence wavelength band on the shorter wavelength side of the wavelength band of Raman scattered light. The fluorescence reference determination unit 302 also determines that the liquid contains chlorophyll contained in green tea when the intensity of light in the second fluorescence wavelength band on the short wavelength side of the wavelength band of Raman scattered light is higher than the intensity of light in the first fluorescence wavelength band on the longer wavelength side of the wavelength band of Raman scattered light.

According to the third embodiment, it is possible to detect that a liquid flowing in piping has been switched from alcohol for disinfection to green tea, for example, in a beverage plant.

### Other Embodiments

The present invention has been described as above based on embodiments. However, it should not be understood that description and drawings forming part of the disclosure limit the invention. Various alternative embodiments, examples, and operation techniques should be clear to those who are skilled in the art according to the disclosure. For example, the combination of the first substance emitting light having higher intensities in the first fluorescence wavelength band than in the second fluorescence wavelength band and the second substance emitting light having higher intensities in the second fluorescence wavelength band than in the first fluorescence wavelength band may comprise a first substance and a second substance that are biotic particles, or where at least one of the first and second substances is a cell. When at least one of the first and second substances is the cell, it is not necessary that the cell is stained.

The intensity of scattering light due to particles is correlated with a particle diameter of the particles. Furthermore, the particle diameter of microorganisms and non-microorganism particles differ according to types of microorganisms and non-microorganism particles. Accordingly, types of microorganisms and non-microorganism particles contained in water may be specified based on detected intensities of scattering light. Additionally, as methods of discriminating types of particles, methods disclosed in U.S. Pat. No. 6,885,440 specification and U.S. Pat. No. 7,106,442 specification may be used. Although the example in which the liquid flowing inside the cell 40 is irradiated with the excitation light is shown in FIG. 1, it is also preferable that a liquid which is not flowing and preserved in a container is irradiated with the excitation light.

It should be understood that the present invention includes various embodiments and so on not described here.

### INDUSTRIAL APPLICABILITY

The present invention can be used in manufacturing sites for purified water for medical applications, purified water for food, purified water for beverages, purified water for manufacturing semiconductor devices, and so on.

### DESCRIPTION OF REFERENCE NUMERALS AND SIGNS

10 light source;
11 light source driving power supply
12 power supply control device
20A first photodetector
20B second photodetector
21A, 21B amplifier
22A, 22B amplifier power supply
23A, 23B light intensity calculation device
24A, 24B light intensity storage device
0 casing
40 cell
50 scattering light photodetector
51 amplifier
52 amplifier power supply
53 light intensity calculation device
54 light intensity storage device
102 fluorescence detection unit
105 scattering light detection unit
300 central processing unit (CPU)
301 comparison unit
302 fluorescence reference determination unit
303 scattering-light reference determination unit
401 output device

1. An in-liquid fluorescence detection device, comprising:
a light source emitting an excitation light having a wavelength in which Raman scattered light is generated in a liquid in a wavelength band between first and second fluorescence wavelength bands toward the liquid; and
a fluorescence detection unit detecting light in the first and second fluorescence wavelength bands to determine a presence in the liquid of a first substance, which emits light having higher intensities in the first fluorescence wavelength band as compared with in the second fluorescence wavelength band, and a second substance, which emits light having higher intensities in the second fluorescence wavelength band as compared with in the first fluorescence wavelength band.

2. The in-liquid fluorescence detection device according to claim 1, further comprising:
a comparison unit comparing an intensity of the detected light in the first fluorescence wavelength band with an intensity of the detected light in the second fluorescence wavelength band.

3. The in-liquid fluorescence detection device according to claim 2, further comprising:
a fluorescence reference determination unit determining that the liquid contains the first substance when the intensity of the detected light in the first fluorescence wavelength band is higher than the intensity of the detected light in the second fluorescence wavelength band, and determining that the liquid contains the second substance when the intensity of the detected light in the second fluorescence wavelength band is higher than the intensity of the detected light in the first fluorescence wavelength band.

4. The in-liquid fluorescence detection device according to claim 1,
wherein the first substance is a biotic particle and the second substance is an abiotic particle.

5. The in-liquid fluorescence detection device according to claim 4,
wherein the first fluorescence wavelength band is positioned on a longer wavelength side than the second fluorescence wavelength band.

6. The in-liquid fluorescence detection device according to claim 4,
wherein an intensity of autofluorescence emitted by the biotic particle in the first fluorescence wavelength band is higher than that of autofluorescence emitted by the abiotic particle in the first fluorescence wavelength band, and
an intensity of autofluorescence emitted by the abiotic particle in the second fluorescence wavelength band is higher than that of autofluorescence emitted by the biotic particle in the second fluorescence wavelength band.

7. The in-liquid fluorescence detection device according to claim 1,
wherein the first and second substances are abiotic particles.

8. The in-liquid fluorescence detection device according to claim 1,
wherein at least one of the first and second substances is a fluorescent substance dissolved in the liquid.

9. The in-liquid fluorescence detection device according to claim 1, further comprising:
a scattering light detection unit detecting scattering light having a same wavelength as the excitation light that is generated in the liquid irradiated with the excitation light.

10. A method of detecting fluorescence in a liquid comprising the steps of:
emitting an excitation light having a wavelength in which Raman scattered light is generated in a liquid in a wavelength band between first and second fluorescence wavelength bands toward the liquid; and
detecting light in the first and second fluorescence wavelength bands to determine a presence in the liquid of a first substance, which emits light having higher intensities in the first fluorescence wavelength band as compared with in the second fluorescence wavelength band, and a second substance, which emits light having higher intensities in the second fluorescence wavelength band as compared with in the first fluorescence wavelength band.

11. The method of detecting fluorescence in the liquid according to claim 10, further comprising the step of:
comparing an intensity of the detected light in the first fluorescence wavelength band with an intensity of the detected light in the second fluorescence wavelength band.

12. The method of detecting fluorescence in the liquid according to claim 11, further comprising the steps of:
determining that the liquid contains the first substance when the intensity of the detected light in the first fluorescence wavelength band is higher than the intensity of the detected light in the second fluorescence wavelength band; and
determining that the liquid contains the second substance when the intensity of the detected light in the second fluorescence wavelength band is higher than the intensity of the detected light in the first fluorescence wavelength band.

13. The method of detecting fluorescence in the liquid according to claim 10,
wherein the first substance is a biotic particle and the second substance is an abiotic particle.

14. The method of detecting fluorescence in the liquid according to claim 13,
wherein the first fluorescence wavelength band is positioned on a longer wavelength side than the second fluorescence wavelength band.

15. The method of detecting fluorescence in the liquid according to claim 13,
wherein an intensity of autofluorescence emitted by the biotic particle in the first fluorescence wavelength band is higher than that of autofluorescence emitted by the abiotic particle in the first fluorescence wavelength band, and
an intensity of autofluorescence emitted by the abiotic particle in the second fluorescence wavelength band is higher than that of autofluorescence emitted by the biotic particle in the second fluorescence wavelength band.

16. The method of detecting fluorescence in the liquid according to claim 10,
wherein the first and second substances are abiotic particles.

17. The method of detecting fluorescence in the liquid according to claim 10,
wherein at least one of the first and second substances is a fluorescent substance dissolved in the liquid.

18. The method of detecting fluorescence in the liquid according to claim 10, further comprising the step of:
detecting scattering light having a same wavelength as the excitation light that is generated in the liquid irradiated with the excitation light.
